(19) United States
(12) Patent Application Publication
(10) Pub. No.: US 2026/0253771 A1
(43) Pub. Date: Aug. 27, 2026

(54) Insulator-Coated Soft Magnetic Powder, Dust Core, Magnetic Element And Electronic Device

(71) Applicant: SEIKO EPSON CORPORATION, Tokyo (JP)

(72) Inventor: Mayu WATANABE, Hachinohe (JP)

(21) Appl. No.: 19/550,745

(22) Filed: Feb. 26, 2026

(30) Foreign Application Priority Data
Feb. 27, 2025 (JP) 2025-030518

(51) Int. Cl. H01F 1/153; B22F 1/05; B22F 1/16; H01F 3/08

(52) U.S. Cl. CPC H01F 1/15383; B22F 1/05; B22F 1/16; H01F 3/08; B22F 2301/35; B22F 2304/10

(57) ABSTRACT

An insulator-coated soft magnetic powder includes:
a soft magnetic powder formed of an Fe—Si—B—C-based amorphous alloy soft magnetic material; and
an insulating coating that coats a surface of the soft magnetic powder and contains a phosphate-based glass;
wherein the average particle diameter is 15.0 μm or more and 40.0 μm or less;
the phosphate-based glass is a glass containing phosphorus oxide as a main component and containing Li; and
the ratio Li/P of the content of Li to the content of P quantified by an elemental analysis method is 0.01 or more and 0.20 or less.

The present application is based on, and claims priority from JP Application Serial Number 2025-030518, filed Feb. 27, 2025, the disclosure of which is hereby incorporated by reference herein in its entirety.

### BACKGROUND

### 1. Technical Field

The present disclosure relates to an insulator-coated soft magnetic powder, a dust core, a magnetic element, and an electronic device.

### 2. Related Art

JP-A-2010-232224 discloses an insulator-coated soft magnetic powder including a particulate core portion formed of a soft magnetic material, a first coating layer covering the core portion, and a second coating layer covering the first coating layer. Among these, the first coating layer is formed by mechanically fixing glass particles. The second coating layer is formed by applying a solution or dispersion of an insulating material and then drying the solution or dispersion.

According to such a configuration, the insulator-coated soft magnetic powder capable of producing a dust core having a surface coated with an insulator and having a small eddy current loss over a long period of time is obtained.

JP-A-2010-232224 is an example of the related art.

In the insulator-coated soft magnetic powder described in JP-A-2010-232224, the insulation property of the first coating layer is not sufficient. Therefore, in the dust core containing the insulator-coated soft magnetic powder, an increase in eddy current loss in a high frequency region is a problem. In addition, there is a problem in that the adhesion of the first coating layer is low.

Accordingly, an insulator-coated soft magnetic powder having good interparticle insulation and good adhesion of the insulating coating has been desired.

### SUMMARY

An insulator-coated soft magnetic powder according to an application example of the present disclosure includes:
a soft magnetic powder formed of an Fe—Si—B—C-based amorphous alloy soft magnetic material; and
an insulating coating that coats a surface of the soft magnetic powder and contains a phosphate-based glass;
wherein the average particle diameter is 15.0 μm or more and 40.0 μm or less;
the phosphate-based glass is a glass containing phosphorus oxide as a main component and containing Li; and
the ratio Li/P of the content of Li to the content of P quantified by an elemental analysis method is 0.01 or more and 0.20 or less.

A dust core according to an application example of the present disclosure includes:
the insulator-coated soft magnetic powder according to the application example of the present disclosure.

A magnetic element according to an application example of the present disclosure includes:
the dust core according to the application example of the present disclosure.

An electronic device according to an application example of the present disclosure includes:
the magnetic element according to the application example of the present disclosure.

### BRIEF DESCRIPTION OF THE DRAWINGS

FIG. 1 is a cross-sectional view schematically showing one particle of an insulator-coated soft magnetic powder according to an embodiment.

FIG. 2 is a plan view schematically showing a toroidal type coil component.

FIG. 3 is a transparent perspective view schematically showing a closed magnetic circuit type coil component.

FIG. 4 is a perspective view showing a mobile personal computer which is an electronic device according to the embodiment.

FIG. 5 is a plan view showing a smartphone which is an electronic device according to the embodiment.

FIG. 6 is a perspective view showing a digital still camera which is an electronic device according to the embodiment.

FIG. 7 is Table 1 showing the composition of an amorphous alloy soft magnetic material contained in the insulator-coated soft magnetic powder.

FIG. 8 is Table 2 showing the composition of a phosphate-based glass contained in an insulating coating of the insulator-coated soft magnetic powder.

FIG. 9 is Table 3 showing the configurations and evaluation results of the insulator-coated soft magnetic powders of sample Nos. 1 to 8.

FIG. 10 is Table 4 showing the configurations and evaluation results of the insulator-coated soft magnetic powders of sample Nos. 9 to 17.

FIG. 11 is Table 5 showing the configurations and evaluation results of the insulator-coated soft magnetic powders of sample Nos. 18 to 26.

### DESCRIPTION OF EMBODIMENTS

Hereinafter, an insulator-coated soft magnetic powder, a dust core, a magnetic element, and an electronic device of the present disclosure will be described in detail based on a preferred embodiment shown in the accompanying drawings.

### 1. Insulator-Coated Soft Magnetic Powder

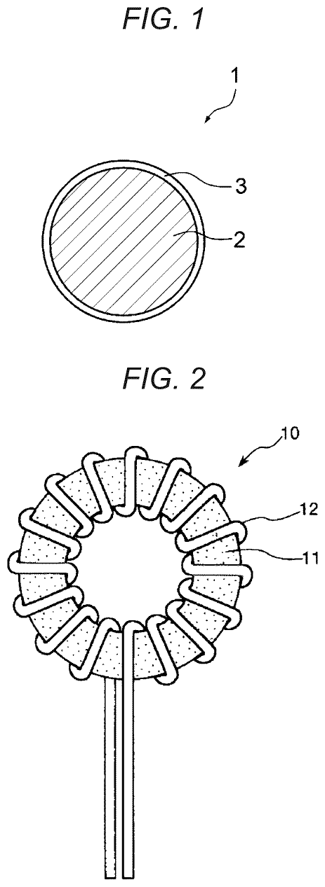

FIG. 1 is a cross-sectional view schematically showing one particle of an insulator-coated soft magnetic powder 1 according to an embodiment. In the following description, each particle of the insulator-coated soft magnetic powder 1 is also referred to as the “insulator-coated soft magnetic powder 1”.

The insulator-coated soft magnetic powder 1 shown in FIG. 1 includes a soft magnetic powder 2 and an insulating coating 3 coating the surface of the soft magnetic powder 2. Among these, the soft magnetic powder 2 is formed of an Fe—Si—B—C-based amorphous alloy soft magnetic material. The insulating coating 3 contains a phosphate-based glass and insulates the particles of the soft magnetic powder 2 from each other. The coating described in the present disclosure includes not only a state in which the entire surface of the soft magnetic powder 2 particles is covered, but also a state in which a part of the particle surface is covered.

The average particle diameter of the insulator-coated soft magnetic powder 1 is 15.0 μm or more and 40.0 μm or less.

The phosphate-based glass contained in the insulating coating 3 is a glass containing phosphorus oxide as a main component and Li (lithium).

Further, when the insulator-coated soft magnetic powder 1 is subjected to qualitative and quantitative analysis by an elemental analysis method, the ratio Li/P of the content of Li to the content of P (phosphorus) quantified is 0.01 or more and 0.20 or less.

According to such a configuration, the insulator-coated soft magnetic powder 1 having good interparticle insulation and good adhesion of the insulating coating is obtained. Therefore, in the dust core obtained by compacting the insulator-coated soft magnetic powder 1, an increase in eddy current loss in a high frequency region can be suppressed. In addition, the electrical insulation between the terminals provided on the dust core can be enhanced.

Hereinafter, the insulator-coated soft magnetic powder 1 according to the embodiment will be described in detail.

### 1.1. Soft Magnetic Powder

The soft magnetic powder 2 is formed of an Fe—Si—B—C-based amorphous alloy soft magnetic material. The Fe—Si—B—C-based amorphous alloy soft magnetic material is a soft magnetic metal material having an amorphous structure and having a composition containing Fe, Si, B, and C as essential elements.

An example of the composition containing Fe, Si, B, and C as essential elements is a composition represented by the composition formula (Fe₁₋ₓCrₓ)ₐ(Si_{1-y}B_{y})_{b}C_{c}. This composition formula represents a ratio in terms of the number of atoms in a composition containing five elements of Fe, Cr, Si, B, and C.

In addition, b is 100-a-c.

Furthermore, 70.0≤a≤82.0, 0<c≤4.0, 0≤x≤0.060, and 0.30≤y≤0.90 are satisfied.

Fe (iron) greatly affects basic magnetic properties and mechanical properties of the amorphous alloy soft magnetic material. The content of Fe is set to be the highest as described above.

Cr (chromium) acts to improve corrosion resistance of the amorphous alloy soft magnetic material. By improving the corrosion resistance, oxidation is inhibited, and deterioration in the magnetic properties associated with the oxidation can be inhibited. Cr is an optional element.

When producing the amorphous alloy soft magnetic material from a raw material, Si (silicon) promotes amorphization and enhances the permeability. In addition, Si acts as a deoxidizing agent and generates silicon oxide distributed on the particle surfaces, thereby contributing to improved adhesion to the insulating coating 3.

B (boron) promotes amorphization when the amorphous alloy soft magnetic material is produced from a raw material. In particular, by using Si and B in combination, amorphization can be synergistically promoted based on a difference in an atomic radius between Si and B.

Carbon (C) lowers the viscosity of a molten material when the raw material for the amorphous alloy soft magnetic material is melted, facilitating amorphization and pulverization. Accordingly, the soft magnetic powder 2 having a small diameter and high permeability can be obtained. As a result, the dust core capable of suppressing eddy current loss in a high frequency region is obtained.

a represents the ratio of the total content of Fe and Cr to the total content when the total mass of the five elements is 100. In the amorphous alloy soft magnetic material, 70.0≤a≤82.0 is preferable, 72.0≤a≤81.5 is more preferable, and 73.0≤a≤81.0 is further preferable.

c represents the content of C when the total mass of the five elements is 100. In the amorphous alloy soft magnetic material, 0<c≤4.0 is preferable, 1.0≤c≤2.8 is more preferable, and 1.5≤c≤2.5 is further preferable.

x represents the ratio of a content of Cr to the total content when the total of the content of Fe and the content of Cr is 1. In the amorphous alloy soft magnetic material, 0≤x≤0.060 is preferable, 0≤x≤0.050 is more preferable, and 0≤x≤0.040 is further preferable.

y represents the ratio of the content of B to the total content when the total of the content of Si and the content of B is 1. In the amorphous alloy soft magnetic material, 0.30 ≤y ≤0.90 is preferable, and 0.40 ≤y ≤0.80 is more preferable.

The composition of the amorphous alloy soft magnetic material has been described above, but the above composition is an example, and the composition is not limited to the above as long as the composition contains Fe, Si, B, and C as essential elements.

The amorphous alloy soft magnetic material according to the embodiment may contain impurities formed of other elements in addition to the elements as described above. A total content of the impurities is preferably 1.0 mass % or less, more preferably 0.2 mass % or less, and further preferably 0.1 mass % or less. In addition, the content of each element alone is preferably 0.2 mass % or less, more preferably 0.1 mass % or less, and further preferably 0.05 mass % or less. When the content is within the range, an effect of the present disclosure is not inhibited by the other elements, and the content is acceptable.

Although the composition of the amorphous alloy soft magnetic material according to the embodiment is described in detail above, the composition and impurities described above are identified by the following analysis method.

Examples of the analysis method include an iron and steel-atomic absorption spectrometric method defined in JIS G 1257:2000, an iron and steel-ICP emission spectrometric method defined in JIS G 1258:2007, an iron and steel-method for spark discharge atomic emission spectrometric analysis defined in JIS G 1253:2002, an iron and steel-method for x-ray fluorescence spectrometric analysis defined in JIS G 1256:1997, and gravimetric, titration and absorption spectrometric methods defined in JIS G 1211 to JIS G 1237.

Specific examples include a solid-state optical emission spectrometer manufactured by SPECTRO, in particular a spark discharge optical emission spectrometer, model: SPECTROLAB, type: LAVMB08A, and an ICP device CIROS120 manufactured by Rigaku Corporation.

In particular, when identifying carbon (C) and sulfur (S), an infrared absorption method after combustion in a current of oxygen (combustion in high frequency induction furnace) defined in JIS G 1211:2011 is also used. Specifically, an example thereof is a carbon and sulfur analyzer CS-200 manufactured by LECO Corporation.

Further, when nitrogen (N) and oxygen (O) are identified, methods for determination of nitrogen content for an iron and steel defined in JIS G 1228:1997 and general rules for determination of oxygen in metal materials defined in JIS Z 2613:2006 are also used. Specifically, examples thereof include an oxygen and nitrogen analyzer, TC-300/EF-300, manufactured by LECO Corporation.

### 1.2. Insulating Coating

The insulating coating 3 contains a phosphate-based glass and covers the soft magnetic powder 2. This phosphate-based glass is a glass containing phosphorus oxide such as P₂O₅ as a main component and Li. When the insulator-coated soft magnetic powder 1 is subjected to qualitative and quantitative analysis by an elemental analysis method, the ratio Li/P of the content of Li to the content of P quantified is 0.01 or more and 0.20 or less. This analysis result reflects the ratio of the contents of P and Li in the insulating coating 3.

Since the insulating coating 3 having such a configuration has good insulation properties, it contributes to the interparticle insulation of the insulator-coated soft magnetic powder 1. In addition, since such an insulating coating 3 has high coating property with respect to the surface of the soft magnetic powder 2, peeling or the like is unlikely to occur, and excellent adhesion is obtained. Due to these effects, in the dust core obtained by compacting the insulator-coated soft magnetic powder 1, an increase in eddy current loss in a high frequency region can be suppressed. In addition, the electrical insulation between the terminals provided on the dust core can be enhanced.

Phosphorus oxide, which is a main component of the phosphate-based glass, contributes to formation of a glass structure having a softening point lower than that of a silicate-based glass. This is considered to contribute to the coating property described above. Therefore, when the insulating coating 3 is formed by, for example, a mechanochemical method, the insulating coating 3 having high coating property can be formed even when the raw material is small or even when the applied energy during film formation is small. The amount ratio of P and O in phosphorus oxide may be an amount ratio other than P₂O₅.

The content of P in qualitative and quantitative analysis of the insulator-coated soft magnetic powder 1 is preferably 10.0 mass % or more and 50.0 mass % or less, more preferably 15.0 mass % or more and 40.0 mass % or less, and further preferably 20.0 mass % or more and 30.0 mass % or less. This makes it possible to obtain the insulating coating 3 that contains phosphorus oxide in an amount necessary and sufficient to exhibit the above effect.

On the other hand, phosphorus oxide has high reactivity between phosphate-bonded (P—O—P) and water, that is, high hygroscopicity. When phosphorus oxide absorbs moisture, the insulation property of the insulating coating 3 may decrease.

Therefore, in the present embodiment, Li is added to the phosphate-based glass. Li is present as lithium oxide such as Li₂O in the phosphate-based glass. Lithium oxide is considered to have an action of weakening intermolecular bonds in the glass structure, thereby further lowering the softening point and viscosity of the phosphate-based glass. In particular, since the ionic radius of Li ions is small, such an action is considered to be strong. As a result, the phosphate-based glass containing Li is softened at a lower temperature and has excellent coating property on the surface of the soft magnetic powder 2. Thus, the insulating coating 3 having high adhesion is obtained. In addition, by reducing the applied energy during the formation of the insulating coating 3, the reactivity of phosphorus oxide with water can be suppressed, and as a result, the hygroscopicity of the phosphate-based glass can be suppressed. From the above, by adding a predetermined amount of Li to the phosphate-based glass, it is possible to suppress a decrease in the insulation property of the insulating coating 3 and to enhance the coating property of the insulating coating 3. The amount ratio of Li and O in lithium oxide may be an amount ratio other than Li₂O.

Since the soft magnetic powder 2 contains Si, Si acting as a deoxidizing agent generates silicon oxide on the particle surface. Since the silicon oxide is a glass component, the silicon oxide exhibits good affinity for the phosphate-based glass. Accordingly, the adhesion of the insulating coating 3 can be further enhanced.

In the phosphate-based glass, the ratio Li/P of the content of Li to the content of P is 0.01 or more and 0.20 or less, preferably 0.03 or more and 0.17 or less, and more preferably 0.05 or more and 0.15 or less.

When the content ratio Li/P is less than the above lower limit value, the amount ratio of lithium oxide to phosphorus oxide decreases, and thus at least one of the insulation property and the adhesion of the insulating coating 3 decreases. On the other hand, when the content ratio Li/P exceeds the above upper limit value, the amount ratio of lithium oxide to phosphorus oxide becomes excessive, which tends to cause an undesirable side effect in which the insulation property and adhesion are conversely deteriorated.

The content of Li in qualitative and quantitative analysis of the insulator-coated soft magnetic powder 1 is preferably 0.5 mass % or more and 5.0 mass % or less, more preferably 1.0 mass % or more and 4.0 mass % or less, and further preferably 1.5 mass % or more and 3.0 mass % or less. This makes it possible to obtain the insulating coating 3 that contains lithium oxide in an amount necessary and sufficient to exhibit the above effect.

The phosphate-based glass may further contain Zn. Zn is present as zinc oxide such as ZnO in the phosphate-based glass. Zinc oxide contributes to stabilization of the glass structure together with phosphorus oxide. In addition, zinc oxide has an effect of delaying the hardening of the raw material during cooling after the raw material has been softened at a high temperature. By this action, the coating property of the insulating coating 3 can be enhanced. The amount ratio of Zn and O in zinc oxide may be an amount ratio other than ZnO.

In the phosphate-based glass, the ratio Li/Zn of the content of Li to the content of Zn is preferably 0.03 or more and 0.30 or less, more preferably 0.05 or more and 0.25 or less, and further preferably 0.07 or more and 0.20 or less.

When the content ratio Li/Zn is less than the above lower limit value, the amount ratio of lithium oxide to zinc oxide decreases, so that the balance between them is disturbed, and at least one of the insulation property and the adhesion of the insulating coating 3 may decrease. On the other hand, when the content ratio Li/Zn exceeds the above upper limit value, the amount ratio of lithium oxide to zinc oxide becomes excessive, and the effects of adding both may be reduced.

The content of Zn in qualitative and quantitative analysis of the insulator-coated soft magnetic powder 1 is preferably 1.0 mass % or more and 20.0 mass % or less, more preferably 5.0 mass % or more and 18.0 mass % or less, and further preferably 10.0 mass % or more and 16.0 mass % or less. This makes it possible to obtain the insulating coating 3 that contains zinc oxide in an amount necessary and sufficient to exhibit the above effect.

The phosphate-based glass may further contain Na. Na is present as sodium oxide such as Na₂O in the phosphate-based glass. Like lithium oxide, sodium oxide lowers the softening point and viscosity of raw materials. The amount ratio of Na and O in sodium oxide may be an amount ratio other than Na₂O.

In the phosphate-based glass, the ratio Li/Na of the content of Li to the content of Na is preferably 0.05 or more and 0.60 or less, more preferably 0.10 or more and 0.50 or less, and further preferably 0.15 or more and 0.40 or less.

When the content ratio Li/Na is less than the above lower limit value, the amount ratio of lithium oxide to sodium oxide decreases, so that the balance between them is disturbed, and at least one of the insulation property and the adhesion of the insulating coating 3 may decrease. On the other hand, when the content ratio Li/Na exceeds the above upper limit value, the amount ratio of lithium oxide to sodium oxide becomes excessive, and the effect of adding both may be reduced.

The content of Na in qualitative and quantitative analysis of the insulator-coated soft magnetic powder 1 is preferably 2.0 mass % or more and 15.0 mass % or less, more preferably 4.0 mass % or more and 11.0 mass % or less, and further preferably 6.0 mass % or more and 9.0 mass % or less. This makes it possible to obtain the insulating coating 3 that contains sodium oxide in an amount necessary and sufficient to exhibit the above effect.

The phosphate-based glass may further contain Al. Al is present as aluminum oxide such as Al₂O₃ in the phosphate-based glass. Aluminum oxide enhances the weather resistance of the insulating coating 3. In addition, aluminum oxide has an effect of delaying the hardening of the raw material during cooling after the raw material has been softened at a high temperature. By this action, the coating property of the insulating coating 3 can be enhanced. The amount ratio of Al and O in the aluminum oxide may be an amount ratio other than Al₂O₃.

In the phosphate-based glass, the ratio Li/Al of the content of Li to the content of Al is preferably 0.20 or more and 2.00 or less, more preferably 0.40 or more and 1.50 or less, and further preferably 0.60 or more and 1.00 or less.

When the content ratio Li/Al is less than the above lower limit value, the amount ratio of lithium oxide to aluminum oxide decreases, so that the balance between them is disturbed, and the adhesion of the insulating coating 3 may decrease. On the other hand, when the content ratio Li/Al exceeds the above upper limit value, the amount ratio of lithium oxide to aluminum oxide becomes excessive, and the effect of adding both may be reduced.

The content of Al in qualitative and quantitative analysis of the insulator-coated soft magnetic powder 1 is preferably 0.5 mass % or more and 5.0 mass % or less, more preferably 1.0 mass % or more and 4.0 mass % or less, and further preferably 2.0 mass % or more and 3.5 mass % or less. This makes it possible to obtain the insulating coating 3 that contains aluminum oxide in an amount necessary and sufficient to exhibit the above effect.

The phosphate-based glass may further contain Si. Si is present as silicon oxide such as SiO₂ in the phosphate-based glass. As described above, since silicon oxide is present on the particle surface of the soft magnetic powder 2, inclusion of silicon oxide in the insulating coating 3 can enhance the affinity between the insulating coating 3 and the soft magnetic powder 2. Accordingly, the adhesion of the insulating coating 3 can be further enhanced.

The content of Si in qualitative and quantitative analysis of the insulator-coated soft magnetic powder 1 is preferably 0.02 mass % or more and 0.30 mass % or less, more preferably 0.04 mass % or more and 0.20 mass % or less, and further preferably 0.06 mass % or more and 0.15 mass % or less.

When the content of Si is less than the above lower limit value, the above affinity may not be sufficiently obtained. On the other hand, when the content of Si exceeds the above upper limit value, the ratio of silicon oxide in the phosphate-based glass increases, which may increase the softening point of the raw material and reduce the coating property of the insulating coating 3.

The content of each of the above elements is quantified by various elemental analysis methods. The elemental analysis method for each element is as follows.
P: Method using an ICP emission spectrometer specified in JIS G 1258-3: 2014
Li: Method using an ICP emission spectrometer specified in JIS G 1258-3: 2014
Zn: Method for the determination of zinc as specified in JIS M 8124:2021
Na: Method for the determination of sodium as specified in JIS M 8207: 2013
Al: Method using an ICP emission spectrometer specified in JIS G 1258-3: 2014
Si: Method using an ICP emission spectrometer specified in JIS G 1258-3: 2014

The amount of the insulating coating 3 in the insulator-coated soft magnetic powder 1 can be represented by a volume fraction. The volume fraction of the insulating coating 3 in the insulator-coated soft magnetic powder 1 is preferably 0.30 volume % or more and 4.00 volume % or less, more preferably 0.40 volume % or more and 2.50 volume % or less, and further preferably 0.50 volume % or more and 1.50 volume % or less. Accordingly, in the insulator-coated soft magnetic powder 1 having the average particle diameter described later, the thickness of the insulating coating 3 can be optimized. Therefore, it is possible to obtain the insulator-coated soft magnetic powder 1 having good interparticle insulation and good adhesion of the insulating coating 3, and a sufficiently increased space factor of the soft magnetic powder 2 when compacted.

When the volume fraction of the insulating coating 3 is less than the above lower limit value, the coating property of the insulating coating 3 may decrease, and the interparticle insulation and the adhesion of the insulating coating 3 may decrease. On the other hand, when the volume fraction of the insulating coating 3 exceeds the upper limit value, the space factor of the soft magnetic powder 2 may decrease.

The volume fraction of the insulating coating 3 is measured as follows.

First, a cross section of a particle of the insulator-coated soft magnetic powder 1 is observed with an electron microscope. Next, the ratio of the area of the insulating coating 3 to the area of the entire particle (area fraction of the insulating coating 3) is measured. The area fraction of the insulating coating 3 thus obtained is adopted as the volume fraction of the insulating coating 3.

### 1.3. Average Particle Diameter

The average particle diameter of the insulator-coated soft magnetic powder 1 is a particle diameter D50 when a cumulative frequency is 50% from a small diameter side in a cumulative particle size distribution on a volume basis of the insulator-coated soft magnetic powder 1 obtained using a laser diffraction type particle size distribution measuring apparatus.

The average particle diameter of the insulator-coated soft magnetic powder 1 is 15.0 μm or more and 40.0 μm or less, preferably 17.0 μm or more and 35.0 μm or less, and more preferably 20.0 μm or more and 30.0 μm or less. Since the insulator-coated soft magnetic powder 1 having such an average particle diameter has a relatively large particle diameter, it has excellent fluidity and thus can achieve good filling property. Accordingly, the density of the green compact can be increased.

When the average particle diameter is less than the lower limit value, the filling property of the insulator-coated soft magnetic powder 1 may decrease depending on the shape of the particles. On the other hand, when the average particle diameter exceeds the upper limit value, the iron loss of the green compact may increase depending on the insulation property of the insulating coating 3.

### 1.4. Crystallinity

The structure of the metal structure of the amorphous alloy soft magnetic material can be evaluated based on the crystallinity. The crystallinity of the amorphous alloy soft magnetic material is calculated from a spectrum obtained by performing crystal structure analysis by an X-ray diffraction method on the insulator-coated soft magnetic powder 1. The crystallinity is calculated based on the following formula.

$$Crystallinity = \{ intensity derived from crystal / ( intensity derived from crystal + intensity derived from amorphous ) \} \times 100$$

As an X-ray diffraction device, for example, RINT2500V/PC manufactured by Rigaku Corporation is used.

The crystallinity measured by such a method is preferably 70% or less, more preferably 60% or less, and further preferably 40% or less. That is, the amorphous alloy soft magnetic material is preferably entirely in an amorphous state and may contain a crystalline structure at a volume ratio of, for example, 70% or less. Thereby, soft magnetism derived from the amorphous structure is stably exhibited.

### 1.5. Withstand Voltage

The insulator-coated soft magnetic powder 1 preferably has a withstand voltage of 250 V or more and 700 V or less, and more preferably 350 V or more and 600 V or less, when 0.7 g of the weighed insulator-coated soft magnetic powder 1 is used as a test object, the test object is placed in a cylinder having an axis in the vertical direction and an inner diameter of 8 mm, and the withstand voltage is measured in a state in which a load of 20 kgf (196 N) is applied to the test object by sandwiching the test object between electrodes from above and below. The insulator-coated soft magnetic powder 1 in which the withstand voltage of the test object is within such a range contributes to implementation of a magnetic element having a large rated voltage even in a small size.

When the withstand voltage is less than the lower limit value, the rated voltage of the magnetic element may not be sufficiently enhanced. On the other hand, the withstand voltage may be more than the upper limit value, but in this case, a variation in the withstand voltage of the magnetic element may increase. In addition, in order to enhance the withstand voltage, it may be necessary to increase the volume fraction of the insulating coating 3.

A method for measuring the withstand voltage is as follows.

First, the insulator-coated soft magnetic powder 1 having a mass of 0.7 g is weighed as the test object. Next, a resin cylinder having an axis in the vertical direction and an inner diameter of 8 mm is prepared, and the test object is placed therein. Next, the test object is sandwiched between two electrodes made of brass in the vertical direction. The electrode is cylindrical in shape having an outer diameter of approximately 8 mm and is in sliding contact with the inner surface of the cylinder. Next, a DC voltage is applied between the electrodes in a state in which a load of 20 kgf (196 N) is applied to the test object via the electrodes. Then, while increasing the voltage in increments of 50 V, an electrical resistance value between the electrodes is measured with a digital multimeter. Further, the voltage when the electrical resistance value is 1 MΩ or less is defined as the withstand voltage. For example, when the electrical resistance value is 1 MΩ or less when the voltage is 550 V, a withstand voltage is set to 500 V.

### 2. Method for Producing Insulator-Coated Soft Magnetic Powder

Next, an example of a method for producing the insulator-coated soft magnetic powder 1 according to the embodiment will be described.

First, a method for producing the soft magnetic powder 2 will be described. The soft magnetic powder 2 may be produced by any method. Examples of the production methods include an atomization method, a reduction method, a carbonyl method, and a pulverization method.

The atomization method is a method for producing a powder by pulverizing a molten raw material and cooling it at the same time by colliding it with a fluid such as a liquid or a gas ejected at a high speed. Examples of the atomization method include a water atomization method, a gas atomization method, and a rotary water jet atomization method, depending on a difference in a type of a cooling medium and a device configuration. Among these, the rotary water jet atomization method is preferably used as the method for producing the soft magnetic powder 2.

In the rotary water jet atomization method, a coolant is injected and supplied along an inner circumferential surface of a cooling tubular body and swirled along the inner circumferential surface of the cooling tubular body to form a coolant layer at the inner circumferential surface. Meanwhile, the raw material is melted, and while allowing the obtained molten metal to freely fall, a liquid or gas jet is blown to the molten metal. When the molten metal is scattered in this manner, the scattered molten metal is taken into the coolant layer. As a result, the scattered and pulverized molten metal is rapidly cooled and solidified, and the soft magnetic powder 2 having a good amorphous structure even with a large diameter is obtained.

The produced soft magnetic powder 2 may be subjected to a classification process as necessary. Examples of the classification process include dry classification such as sieving classification, inertial classification, centrifugal classification, and air classification, and wet classification such as sedimentation classification. The classification process may be performed after the formation of the insulating coating 3.

The produced soft magnetic powder 2 may be subjected to a heat treatment as necessary. The heat treatment is performed for the purpose of relaxing the stress remaining in the soft magnetic powder 2. In addition, an oxide film having an appropriate film thickness can also be formed at the particle surface of the soft magnetic powder 2 by the heat treatment. A main component of the oxide film is silicon oxide. The heat treatment may be performed after the formation of the insulating coating 3.

The temperature of the heat treatment is preferably 350° C. or more and 450° C. or less, and more preferably 370° C. or more and 430° C. or less. The time for holding this temperature is preferably 5 minutes or more and 60 minutes or less, and more preferably 10 minutes or more and 30 minutes or less. As the atmosphere of the heat treatment, an inert atmosphere such as a nitrogen atmosphere is preferably used. By performing the heat treatment under these conditions, the oxide film having good adhesion to the insulating coating 3 can be formed.

Next, a method of forming the insulating coating 3 will be described. A method of forming the insulating coating 3 is not particularly limited, and examples thereof include a mechanochemical method, a gas phase film formation method, and a liquid phase film formation method. Examples of the gas phase film formation method include a plasma polymerization method, an atomic layer deposition (ALD) method, a chemical vapor deposition (CVD) method, and an ion plating method. Examples of the liquid phase film formation method include a sol-gel method and an electrolytic reduction method. Among these, the mechanochemical method is preferably used.

The mechanochemical method is a method in which mechanical stress is applied to particles of phosphate-based glass to change physicochemical properties thereof. For example, by using a mechanochemical reaction device having a cylindrical chamber that rotates at a high speed and is provided with a compression tool and a blade inside, a mechanical interaction (mechanochemical reaction) is generated between the soft magnetic powder 2 and particles of phosphate-based glass, thereby forming the insulating coating 3.

Examples of the mechanochemical reaction devices include a “Nobilta” (registered trademark) pulverizer and a “Mechanofusion” (registered trademark) pulverizer manufactured by Hosokawa Micron Corporation, and a “Hybridizer” (registered trademark) pulverizer manufactured by Nara Machinery Works, Ltd.

### 3. Dust Core and Magnetic Element

Next, the dust core and the magnetic element according to the embodiment will be described.

The magnetic element according to the embodiment can be applied to various magnetic elements including a magnetic core, such as a choke coil, an inductor, a noise filter, a reactor, a transformer, a motor, an actuator, a solenoid valve, and a generator. The dust core according to the embodiment can be applied to a magnetic core provided to these magnetic elements.

Hereinafter, two types of coil components will be representatively described as an example of the magnetic element.

### 3.1. Toroidal Type

First, a toroidal type coil component, which is the magnetic element according to the embodiment, will be described.

FIG. 2 is a plan view schematically showing the toroidal type coil component 10. The coil component 10 shown in FIG. 2 includes a ring-shaped dust core 11 and a conductive wire 12 wound around the dust core 11.

The dust core 11 is obtained by mixing the insulator-coated soft magnetic powder described above and a binder, supplying the obtained mixture to a mold, and pressurizing and molding. That is, the dust core 11 is a green compact containing the insulator-coated soft magnetic powder according to the embodiment. The coil component 10 including such a dust core 11 has good insulation properties between terminals, low iron loss, and good magnetic properties. Therefore, the coil component 10 can contribute to low power consumption, size reduction, and high output of the electronic device.

Examples of a constituent material of the binder used for producing the dust core 11 include organic materials such as silicone-based resins, epoxy-based resins, phenol-based resins, polyamide-based resins, polyimide-based resins, and polyphenylene sulfide-based resins, and inorganic materials such as phosphates such as magnesium phosphate, calcium phosphate, zinc phosphate, manganese phosphate, and cadmium phosphate, and silicates such as sodium silicate.

Examples of a constituent material of the conductive wire 12 include a material having high conductivity, for example, a metal material including Cu, Al, Ag, Au, and Ni. An insulating film is provided on the surface of the conductive wire 12 as necessary.

A shape of the dust core 11 is not limited to the ring shape shown in FIG. 2, and may be, for example, a shape in which a part of the ring is missing, or a shape in which a shape in a longitudinal direction is linear.

The dust core 11 may contain, as necessary, a soft magnetic powder other than the insulator-coated soft magnetic powder according to the embodiment, or a non-magnetic powder.

### 3.2. Closed Magnetic Circuit Type

Next, a closed magnetic circuit type coil component, which is the magnetic element according to the embodiment, will be described.

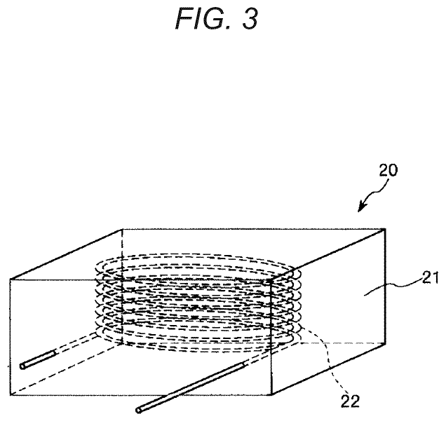

FIG. 3 is a transparent perspective view schematically showing the closed magnetic circuit type coil component 20.

Hereinafter, the closed magnetic circuit type coil component 20 will be described. In the following description, differences from the toroidal type coil component 10 will mainly be described, and description of similar matters will be omitted.

The coil component 20 shown in FIG. 3 includes a dust core 21 having a chip shape and a conductive wire 22 embedded in the dust core 21 and formed into a coil shape. That is, the dust core 21 is a green compact containing the insulator-coated soft magnetic powder according to the embodiment. The coil component 20 including such a dust core 21 has good insulation properties between terminals, low iron loss, and good magnetic properties. Therefore, the coil component 20 described above can contribute to low power consumption, size reduction, and high output of the electronic device.

The dust core 21 may contain, as necessary, a soft magnetic powder other than the insulator-coated soft magnetic powder according to the embodiment, or a non-magnetic powder.

### 4. Electronic Device

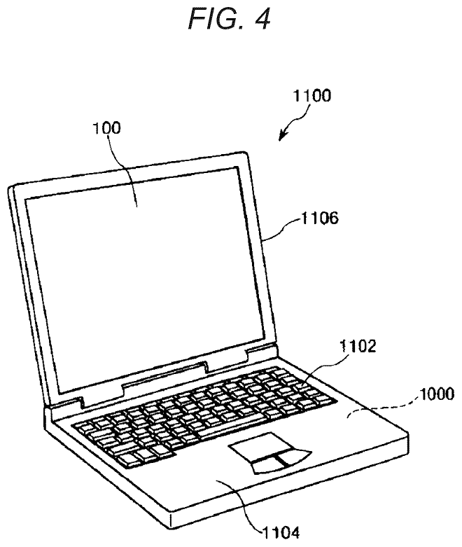

Next, an electronic device according to the embodiment will be described with reference to FIGS. 4 to 6.

FIG. 4 is a perspective view showing a mobile personal computer 1100 which is the electronic device according to the embodiment. The personal computer 1100 shown in FIG. 4 includes a main body 1104 including a keyboard 1102 and a display unit 1106 including a display 100. The display unit 1106 is pivotally supported by the main body 1104 via a hinge structure. Such a personal computer 1100 includes therein a magnetic element 1000 such as a choke coil, an inductor, or a motor for a switching power supply.

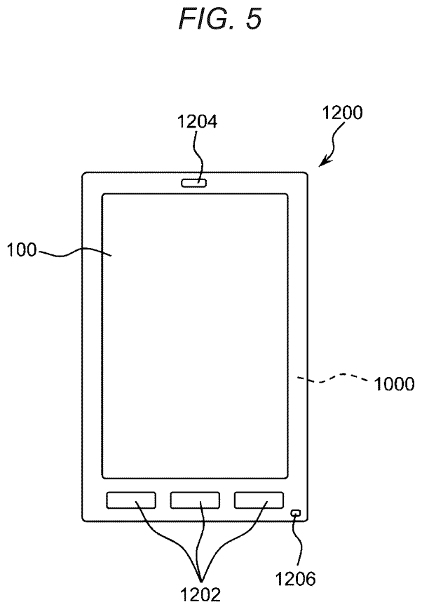

FIG. 5 is a plan view showing a smartphone 1200 which is the electronic device according to the embodiment. The smartphone 1200 shown in FIG. 5 includes a plurality of operation buttons 1202, an earpiece 1204, and a mouthpiece 1206. In addition, the display 100 is disposed between the operation buttons 1202 and the earpiece 1204. Such a smartphone 1200 includes therein the magnetic element 1000 such as an inductor, a noise filter, or a motor.

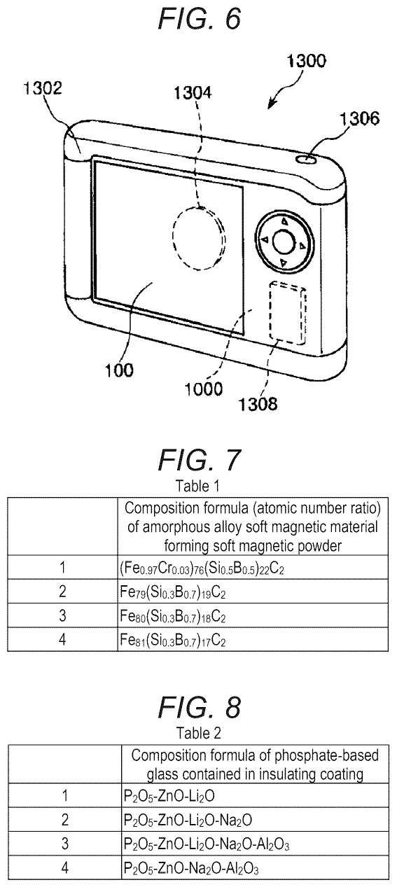

FIG. 6 is a perspective view showing a digital still camera 1300 which is the electronic device according to the embodiment. The digital still camera 1300 photoelectrically converts an optical image of a subject with an imaging element such as a charge coupled device (CCD) to generate an imaging signal.

The digital still camera 1300 shown in FIG. 6 includes the display 100 provided at a rear surface of a case 1302. The display 100 functions as a finder which displays a subject as an electronic image. A light receiving unit 1304 including an optical lens, a CCD, and the like is provided on a front surface side of the case 1302, that is, on a back surface side in the drawing.

When a photographer confirms a subject image displayed on the display 100 and presses a shutter button 1306, a CCD imaging signal at this time is transferred to and stored in a memory 1308. Such a digital still camera 1300 also includes therein the magnetic element 1000 such as an inductor or a noise filter.

Such an electronic device includes the magnetic element according to the embodiment. As a result, the electronic device with low power consumption, size reduction, and high output can be obtained.

Examples of the electronic device according to the embodiment include, in addition to the personal computer in FIG. 4, the smartphone in FIG. 5, and the digital still camera in FIG. 6, a mobile phone, a tablet terminal, a watch, inkjet discharge devices such as an inkjet printer, a laptop personal computer, a television, a video camera, a video tape recorder, a car navigation device, a pager, an electronic notebook, an electronic dictionary, a calculator, an electronic game device, a word processor, a workstation, a videophone, a crime prevention television monitor, electronic binoculars, a POS terminal, medical devices such as an electronic thermometer, a blood pressure meter, a blood glucose meter, an electrocardiogram measurement device, an ultrasonic diagnostic device, and an electronic endoscope, a fish finder, various measuring devices, instruments for a vehicle, an aircraft, and a ship, moving object control devices such as an automobile control device, an aircraft control device, a railway vehicle control device, and a ship control device, and a flight simulator.

### 5. Effects of Embodiment

As described above, the insulator-coated soft magnetic powder 1 according to the embodiment includes the soft magnetic powder 2 and the insulating coating 3. The soft magnetic powder 2 is formed of an Fe—Si—B—C-based amorphous alloy soft magnetic material. The insulating coating 3 covers the surface of the soft magnetic powder 2 and contains phosphate-based glass. In addition, the average particle diameter of the insulator-coated soft magnetic powder 1 is 15.0 μm or more and 40.0 μm or less. Further, the phosphate-based glass is a glass containing phosphorus oxide as a main component and Li. For the insulator-coated soft magnetic powder 1, the ratio Li/P of the content of Li to the content of P quantified by an elemental analysis method is 0.01 or more and 0.20 or less.

According to such a configuration, the insulator-coated soft magnetic powder 1 having good interparticle insulation and good adhesion of the insulating coating is obtained. Therefore, in the dust core obtained by compacting the insulator-coated soft magnetic powder 1, an increase in eddy current loss in a high frequency region can be suppressed. In addition, the electrical insulation between the terminals provided on the dust core can be enhanced.

In the insulator-coated soft magnetic powder 1 according to the embodiment, the phosphate-based glass may further contain Zn. In this case, the ratio Li/Zn of the content of Li to the content of Zn quantified by an elemental analysis method is preferably 0.03 or more and 0.30 or less.

According to such a configuration, zinc oxide contributes to stabilization of the glass structure together with phosphorus oxide. For this reason, zinc oxide has an effect of delaying the hardening of the raw material during cooling after the raw material has been softened at a high temperature. By this action, the coating property of the insulating coating 3 can be enhanced.

In the insulator-coated soft magnetic powder 1 according to the embodiment, the phosphate-based glass may further contain Na. In this case, the ratio Li/Na of the content of Li to the content of Na quantified by an elemental analysis method is preferably 0.05 or more and 0.60 or less.

According to such a configuration, like lithium oxide, sodium oxide can lower the softening point and viscosity of raw materials.

The insulator-coated soft magnetic powder 1 according to the embodiment preferably has a withstand voltage of 250 V or more and 700 V or less when 0.7 g of the weighed insulator-coated soft magnetic powder 1 is used as a test object, the test object is placed in a cylinder having an inner diameter of 8 mm and an axis in the vertical direction, and the withstand voltage is measured in a state in which a load of 20 kgf (196 N) is applied to the test object by sandwiching the test object between electrodes from above and below.

According to such a configuration, the insulator-coated soft magnetic powder 1 that contributes to the implementation of a magnetic element that is small but has a high rated voltage can be obtained.

In the insulator-coated soft magnetic powder 1 according to the embodiment, the volume fraction of the insulating coating 3 is preferably 0.30 volume % or more and 4.00 volume % or less.

According to such a configuration, in the insulator-coated soft magnetic powder 1 having the average particle diameter described above, the thickness of the insulating coating 3 can be optimized. Therefore, it is possible to obtain the insulator-coated soft magnetic powder 1 having good interparticle insulation and good adhesion of the insulating coating 3, and a sufficiently increased space factor of the soft magnetic powder 2 when compacted.

The dust core according to the embodiment includes the insulator-coated soft magnetic powder 1 according to the embodiment.

According to such a configuration, it is possible to obtain the dust core that enables a magnetic element having good insulation properties between terminals, low iron loss, and good magnetic properties.

The magnetic element according to the embodiment includes the dust core according to the embodiment.

According to such a configuration, it is possible to obtain the magnetic element having good insulation properties between terminals, low iron loss, and good magnetic properties.

The electronic device according to the embodiment includes the magnetic element according to the embodiment.

According to such a configuration, the electronic device with low power consumption, size reduction, and high output can be obtained.

The insulator-coated soft magnetic powder, the dust core, the magnetic element, and the electronic device of the present disclosure are described above based on the preferred embodiment, and the present disclosure is not limited thereto. For example, the dust core and the magnetic element according to the present disclosure may be what is obtained by replacing each unit of the embodiment described above with any component having the same function, or what is obtained by adding any constituent to the embodiment described above.

In addition, in the above embodiment, a dust core is described as an example of an application of the insulator-coated soft magnetic powder of the present disclosure, and the application example is not limited thereto, and may be, for example, a magnetic fluid, a magnetic shielding sheet, and a magnetic device such as a magnetic head. In addition, shapes of the dust core and the magnetic element are not limited to those shown in the drawings, and any shapes may be adopted.

### Example

Next, specific examples of the present disclosure will be described.

### 6. Production of Insulator-Coated Soft Magnetic Powder

FIG. 7 is Table 1 showing the composition of an amorphous alloy soft magnetic material contained in the insulator-coated soft magnetic powder.

FIG. 8 is Table 2 showing the composition of a phosphate-based glass contained in the insulating coating of the insulator-coated soft magnetic powder.

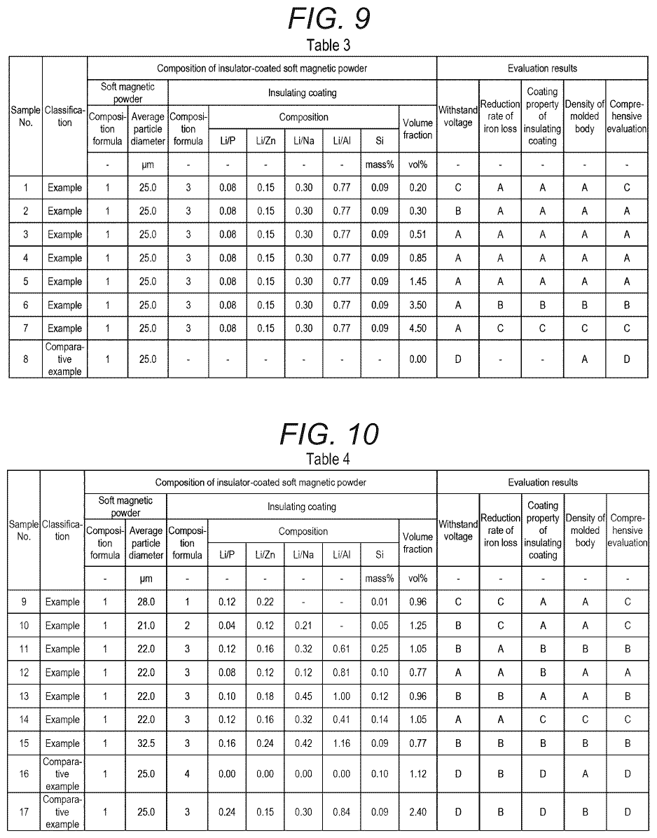

FIG. 9 is Table 3 showing the configurations and evaluation results of the insulator-coated soft magnetic powders of sample Nos. 1 to 8.

FIG. 10 is Table 4 showing the configurations and evaluation results of the insulator-coated soft magnetic powders of sample Nos. 9 to 17.

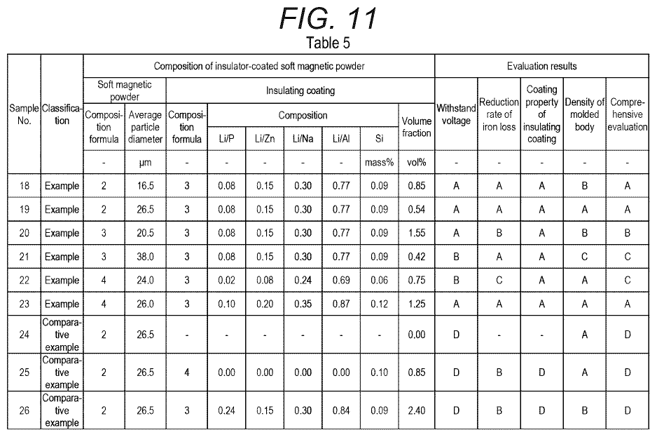

FIG. 11 is Table 5 showing the configurations and evaluation results of the insulator-coated soft magnetic powders of sample Nos. 18 to 26.

### 6.1. Sample Nos. 1 to 7

First, a raw material was melted in a high frequency induction furnace and pulverized by a rotary water jet atomization method to obtain a metal powder.

Next, the obtained metal powder was subjected to a heat treatment. A heating temperature of the heat treatment was 410° C., a time for holding the heating temperature (heating time) was 15 minutes, and a furnace atmosphere was a nitrogen atmosphere.

Next, classification was performed by a classifier using a mesh having an opening of 53 μm. The classified metal powder was recovered as a soft magnetic powder. The composition of the recovered soft magnetic powder is shown in Table 1. The composition was determined using a solid-state optical emission spectrometer manufactured by SPECTRO, model: SPECTROLAB, type: LAVMB08A.

Next, the insulating coating was formed at the surfaces of the soft magnetic powder. Accordingly, the insulator-coated soft magnetic powders of Sample Nos. 1 to 7 were obtained. A mechanochemical method was used to form the insulating coating. The composition of the phosphate-based glass contained in the insulating coating is shown in Table 2.

Next, the contents of P, Li, Zn, Na, Al, and Si contained in the insulating coating were measured by the method described above. Then, the content ratios Li/P, Li/Zn, Li/Na, and Li/Al were calculated. The calculation results are shown in Tables 3 to 5. The measurement results of the Si content are shown in Tables 3 to 5.

Next, the volume fraction of the insulating coating was calculated by the method described above. The calculation results are shown in Tables 3 to 5.

### 6.2. Sample No. 8

The formation of the insulating coating was omitted, and the amorphous alloy soft magnetic powder was used as it was as a soft magnetic powder of Sample No. 8.

### 6.3. Sample Nos. 9 to 17

The insulator-coated soft magnetic powders of Sample Nos. 9 to 17 were obtained in the same manner as in Sample Nos. 1 to 7, except that their configuration was changed as shown in Table 4.

### 6.4. Sample Nos. 18 to 23

The insulator-coated soft magnetic powders of Sample Nos. 18 to 23 were obtained in the same manner as in Sample Nos. 1 to 7, except that their configuration was changed as shown in Table 5.

### 6.5. Sample No. 24

The formation of the insulating coating was omitted, and the amorphous alloy soft magnetic powder was used as it was as a soft magnetic powder of Sample No. 24.

### 6.6. Sample Nos. 25 to 26

The insulator-coated soft magnetic powders of Sample Nos. 25 to 26 were obtained in the same manner as in Sample Nos. 1 to 7, except that their configuration was changed as shown in Table 5.

Furthermore, in Tables 3 to 5, the samples which correspond to the present disclosure are referred to as “Example”, and samples which do not correspond to the present disclosure are referred to as “Comparative Example”.

### 7. Evaluation of Insulator-Coated Soft Magnetic Powder

The insulator-coated soft magnetic powders of each sample No. were evaluated as follows.

### 7.1. Withstand Voltage

The withstand voltage of a test object produced from the insulator-coated soft magnetic powders of each sample No. was measured by the method described above. Then, the measurement results were evaluated based on the following evaluation criteria. The evaluation results are shown in Tables 3 to 5.
A: The withstand voltage is 350 V or more
B: The withstand voltage is 300 V or more and less than 350 V
C: The withstand voltage is 250 V or more and less than 300 V
D: The withstand voltage is less than 250 V

### 7.2. Reduction Rate of Iron Loss

The iron loss (kW/m³) of the soft magnetic powders (powders before forming the insulating coating) used for producing the insulator-coated soft magnetic powders of each sample No. was measured by the following method. This measurement result is referred to as “iron loss P1”.

First, an epoxy resin in an amount equivalent to 2.0 mass % of the soft magnetic powder was mixed with the soft magnetic powder, and the obtained mixture was warm-compacted at a temperature of 70° C. and a pressure of 49.0 MPa (0.5 t/cm²). Accordingly, a ring-shaped green compact having an outer diameter of 14 mm, an inner diameter of 8 mm, and a thickness of 3 mm was obtained. Next, a copper wire having a wire diameter of 0.16 mm was wound around the obtained green compact in 18 turns on a primary side and 18 turns on a secondary side to obtain a test object. Next, the iron loss of the obtained test object was measured. The iron loss was measured using a BH Analyzer SY-8218 manufactured by IWATSU ELECTRIC CO., LTD. The measurement frequency of the iron loss was 1 MHz, and the maximum magnetic flux density during the iron loss measurement was 20 mT.

Next, the iron losses (kW/m³) of the insulator-coated soft magnetic powders of each sample No. were measured by the same method as described above. This measurement result is referred to as “iron loss P2”.

Next, the reduction rate of the iron loss due to the formation of the insulating coating was calculated by the following formula.

$$Reduction rate of iron loss = ( P 1 - P 2 ) / P 1$$

Subsequently, the calculated iron loss reduction rate was evaluated based on the following criteria. The evaluation results are shown in Tables 3 to 5.
A: The reduction rate of iron loss is less than 7%
B: The reduction rate of iron loss is 7% or more and less than 10%
C: The reduction rate of iron loss is 10% or more and less than 13%
D: The reduction rate of iron loss is 13% or more

### 7.3. Coating Property of Insulating Coating

The surfaces of the insulator-coated soft magnetic powders for each sample were subjected to elemental mapping analysis using energy-dispersive X-ray spectroscopy (EDS). Then, the coating property of the insulating coating was evaluated by comparing the distribution of the elements contained in the insulating coating with the following criteria. The evaluation results are shown in Tables 3 to 5.
A: The coating property of the insulating coating is particularly good (elemental distribution is particularly uniform)
B: The coating property of the insulating coating is moderately good (elemental distribution shows slight non-uniformity)
C: The coating property of the insulating coating is partially insufficient (elemental distribution shows non-uniformity within an acceptable range)
D: The coating property of the insulating coating is poor (elemental distribution shows significant non-uniformity)

### 7.4. Density of Molded Body

The density of the molded body produced from the insulator-coated soft magnetic powders for each sample No. was calculated by the following method.

First, an epoxy resin corresponding to 2.0 mass % of the insulator-coated soft magnetic powder and the insulator-coated soft magnetic powder were mixed and compressed at a pressure of 49.0 MPa (0.5 t/cm²) to be molded. Next, the obtained molded body was subjected to a heat treatment at 150° C. for 30 minutes in an air atmosphere. Accordingly, a ring-shaped molded body having an outer diameter of 14 mm, an inner diameter of 8 mm, and a thickness of 3 mm was obtained. Next, a volume and a mass of the obtained molded body were measured. Meanwhile, a particle density of the used insulator-coated soft magnetic powder was measured. A dry automatic density meter capable of measurement by a gas displacement method was used to measure the particle density. Next, a density of the molded body was calculated based on the volume and the mass of the molded body, and the relative density of the molded body was calculated based on the density and the particle density of the obtained molded body.

Next, the density of the molded body was evaluated by comparing the calculated relative density with the following evaluation criteria. The evaluation results are shown in Tables 3 to 5.
A: The density of the molded body is particularly high (particularly good magnetic properties are obtained)
B: The density of the molded body is moderately high (necessary and sufficient magnetic properties are obtained)
C: The density of the molded body is moderately low but within an acceptable range (the necessary magnetic properties are obtained)
D: The density of the molded body is low (the necessary magnetic properties are not obtained)

### 7.5. Comprehensive Evaluation

Each insulator-coated soft magnetic powder was comprehensively evaluated by comparing the above evaluation results with the following evaluation criteria. The evaluation results are shown in Tables 3 to 5.
A: None of the above four evaluation results include C or lower, and one or fewer B ratings are included
B: None of the above four evaluation results include C or lower, and two or more B ratings are included
C: None of the above four evaluation results include D, and at least one C rating is included
D: The above four evaluation results include D

As shown in Tables 3 to 5, in the insulator-coated soft magnetic powder of each example, the withstand voltage, the reduction rate of the iron loss due to the formation of the insulating coating, the coating property of the insulating coating, and the density of the molded body were good. This result is considered to be due to the fact that, in the insulator-coated soft magnetic powder of each example, the interparticle insulation is good, the coating property of the insulating coating is good, peeling or the like is small (adhesion is good), and thickening is suppressed.

What is claimed is:

1. An insulator-coated soft magnetic powder comprising:
a soft magnetic powder formed of an Fe—Si—B—C-based amorphous alloy soft magnetic material; and
an insulating coating that coats a surface of the soft magnetic powder and contains a phosphate-based glass;
wherein the average particle diameter is 15.0 μm or more and 40.0 μm or less;
the phosphate-based glass is a glass containing phosphorus oxide as a main component and containing Li; and
the ratio Li/P of the content of Li to the content of P quantified by an elemental analysis method is 0.01 or more and 0.20 or less.

2. The insulator-coated soft magnetic powder according to claim 1, wherein the phosphate-based glass further contains Zn, and
the ratio Li/Zn of the content of Li to the content of Zn quantified by an elemental analysis method is 0.03 or more and 0.30 or less.

3. The insulator-coated soft magnetic powder according to claim 1, wherein the phosphate-based glass further contains Na, and
the ratio Li/Na of the content of Li to the content of Na quantified by an elemental analysis method is 0.05 or more and 0.60 or less.

4. The insulator-coated soft magnetic powder according to claim 1, wherein the insulator-coated soft magnetic powder has a withstand voltage of 250 V or more and 700 V or less when 0.7 g of the weighed insulator-coated soft magnetic powder is used as a test object, the test object is placed in a cylinder having an inner diameter of 8 mm and an axis in the vertical direction, and
the withstand voltage is measured in a state in which a load of 20 kgf (196 N) is applied to the test object by sandwiching the test object between electrodes from above and below.

5. The insulator-coated soft magnetic powder according to claim 1, wherein a volume fraction of the insulating coating is 0.30 volume % or more and 4.00 volume % or less.

6. A dust core comprising:
the insulator-coated soft magnetic powder according to claim 1.

7. A magnetic element comprising:
the dust core according to claim 6.

8. An electronic device comprising:
the magnetic element according to claim 7.
